(19) United States
(12) Patent Application Publication
(10) Pub. No.: US 2021/0039767 A1
(43) Pub. Date: Feb. 11, 2021

(54) AEROFOIL

(71) Applicant: ROLLS-ROYCE plc, London (GB)

(72) Inventors: Chaitanya PARUCHURI, Southampton (GB); Philip JOSEPH, Southampton (GB)

(73) Assignee: ROLLS-ROYCE plc, London (GB)

(21) Appl. No.: 16/983,324

(22) Filed: Aug. 3, 2020

(30) Foreign Application Priority Data
Aug. 7, 2019 (GB) 1911291.1

(51) Int. Cl. B64C 3/14; B64C 5/00; F01D 9/04

(52) U.S. Cl. CPC B64C 3/14; B64C 5/00; F05D 2240/124; F05D 2260/96; F05D 2240/121; F01D 9/041

(57) ABSTRACT

An aerofoil has a leading edge, a trailing edge, a suction surface and a pressure surface. The leading edge includes apertures extending through the aerofoil from the suction surface to the pressure surface. The apertures define a first row spaced a distance (L₁) of between 2 and 6 cm from the leading edge in a chordal direction (C).

### CROSS-REFERENCE TO RELATED APPLICATIONS

This specification is based upon and claims the benefit of priority from United Kingdom patent application number GB1911291.1 filed on 7^{th} Aug. 2019, the entire contents of which are incorporated herein by reference.

### BACKGROUND

### Technical Field

The present disclosure concerns an aerofoil, particularly but not exclusively, an aerofoil fora gas turbine engine having a reduced broadband noise profile in use.

### Description of the Related Art

Noise from aircraft is an ongoing environmental concern. There are typically several sources of noise from an aircraft, including jet noise produced by shear interaction between the jet exhaust from gas turbine engines, and aerodynamic noise caused primarily by turbulent air created by the flow of air over aircraft surfaces. One source of noise is due to interaction between a wake resulting from an upstream component such as a fan or propeller rotor impinging on the leading edge of a downstream component such as an Outlet Guide Vane (OGV).

As aircraft engine bypass ratios increase, aircraft aerodynamic noise is becoming a relatively large contributor to overall aircraft noise. In particular, turbulence created on the leading and trailing edges of aerofoil surfaces is thought to produce a significant proportion of noise produced by an aircraft. Noise created by these mechanisms often has a wide range of frequencies (known as “broadband noise”), and is particularly difficult to eliminate.

Examples of aerofoils on aircraft include the wings and tail surfaces, as well as smaller components such as control surfaces and high lift devices such as flaps and slats. The gas turbine engines of the aircraft also typically include several aerofoils, including compressor and turbine rotors and stators, fan rotors and Outlet Guide Vanes (OGV). The gas turbine engine nacelle is also typically aerofoil shaped.

It has been proposed to provide porous aerofoils to reduce noise. For instance, aerofoils made of porous metal foams have been proposed, for example in Reduction of Turbulence Interaction Noise Through Airfoils With Perforated Leading Edges, Thomas F Geyer et al, Acta Acustica united with Acustica, Volume 105, Number 1, January/February 2019, pp. 109-122(14). However, such porous aerofoils are difficult to manufacture, and result in a relatively small reduction in noise. Furthermore, these prior porous aerofoils are relatively delicate, particularly where applied to a leading edge that may be subject to Foreign Object Damage (FOD) such as bird strikes, or to leading edges of relatively thin aerofoils. Finally, a porous leading edge may result in significant aerodynamic penalties, such as increased drag.

In this document, the term “chord” will be understood to refer to the distance between the leading and trailing edge of an aerofoil, measured parallel to the normal in use airflow over the wing. The term “chordal” will be understood to refer to a direction parallel to the chord. The term “span” will be understood to refer to a direction generally normal to the chord, extending between a root and a tip of an aerofoil component. The term “spanwise” will be understood as a direction the direction of the span.

### SUMMARY

According to a first aspect of the disclosure there is provided an aerofoil having a leading edge, a trailing edge, a suction surface and a pressure surface, the leading edge comprising a plurality of apertures extending through the aerofoil from the suction surface to the pressure surface, the plurality of apertures defining a first row spaced from the leading edge, wherein the first row of apertures may be spaced a distance L₁ of between 2 and 6 cm from the leading edge in a chordal direction.

Advantageously, it has been found that, by providing a row of apertures extending through the aerofoil spaced from the leading edge by between 2 and 6 cm, noise generated by interaction of the aerofoil with upstream turbulent flow is greatly reduced, particular in the range of frequencies easily perceived by humans. Furthermore, the disclosed aerofoil is robust, straightforward to manufacture, and resistant to damage due to FOD.

The first row of apertures may be spaced from the leading edge by between 25% and 40% of a chordal length of the aerofoil.

The aerofoil component may define a distance L₀, comprising a distance between the leading edge and a downstream end of a row of apertures furthest from the leading edge. The distance L₀ may be defined as:

$${L}_{0} = \frac{U}{f}$$

where U is an in-use oncoming airspeed velocity, and f is an in-use principle frequency of noise impinging on the leading edge.

At least one aperture may define a width of between 2 and 4 mm. It has been found that, by providing apertures with a width in this range, optimum noise reduction is achieved. For example, apertures having a smaller width than the above minimum width have been found to provide insufficient noise to cancel noise from the leading edge, whereas apertures having a larger width than the above maximum width have been found to produce excessive low frequency noise. Furthermore, larger apertures have been found to have adverse aerodynamic effects, and may negatively affect the strength of the structure.

At least one aperture may define a generally circular profile when viewed from above the suction or pressure surface. Alternatively, at least one aperture may define a generally cross-shaped or star-shaped profile. It has been found that cross or star shaped apertures can be particularly effective in reducing high frequency noise. The row of apertures may comprise difference shaped apertures.

The or each row of apertures may comprise a spanwise aperture spacing of between 3 and 6 mm.

The aerofoil may comprise a plurality of rows of apertures.

The row or rows of apertures may define a porous region of the aerofoil. The porous region may define a porosity of between 5% and 35%.

The aerofoil may comprise a cover moveable between a first position in which one or more apertures are exposed, and a second position in which one or more apertures are covered by the cover. Advantageously, the apertures can be selectively covered and uncovered, thereby minimising any aerodynamic disadvantage to times where the reduced noise signature is required.

The aerofoil component may comprise an aerofoil of a gas turbine engine, such as an outlet guide vane (OGV) provided downstream in use of a fan, or a stator or rotor of an axial flow compressor.

According to a second aspect of the present disclosure there is provided a gas turbine engine comprising an aerofoil component in accordance with the first aspect of the present disclosure.

The gas turbine engine may comprise an upstream component upstream of the aerofoil component. The upstream component may comprise a fan, and the aerofoil component may comprise an outlet guide vane downstream in use of the fan. Alternatively or in addition, the gas turbine engine may comprise an axial flow compressor, comprising at least one compressor rotor and at least one compressor stator, wherein the rotor comprises the upstream component and the stator comprises the aerofoil component, or the stator comprises the upstream component and the rotor comprises the aerofoil component.

The gas turbine engine may be configured to define an in use maximum airflow velocity as measured at a leading edge of the aerofoil component. The aerofoil component may define a distance L₀, comprising a distance between the leading edge and a downstream end of a row of apertures furthest from the leading edge.

The distance L₀ may be defined as:

$${L}_{0} = \frac{U}{f}$$

where U is the oncoming airspeed velocity, and f is a principle frequency of noise generated by the upstream component.

According to a third aspect of the present disclosure there is provided an aircraft comprising an aerofoil component in accordance with the first aspect of the present disclosure.

The aerofoil may comprise one of a wing, a vertical stabiliser, a horizontal stabiliser, a canard, a high lift device, and a control surface.

Where the aerofoil comprises a wing, the aerofoil may comprise a slat upstream of the row of apertures. The slat may be configured to be moveable between a first position, wherein the slat covers the row of apertures, and a second position, wherein the slat uncovers the apertures. Advantageously, the slat serves to both modulate lift provided by the wing, and control covering and uncovering of the row of apertures. Since increased lift is typically required during take-off and landing, where the aircraft is close to the ground, reduced noise is required during the same phase of operation that increased lift is required. Consequently, a single actuator can be used to both increase lift and reduce noise, while providing for increased aerodynamic performance where the flap is retracted and the apertures are covered.

According to a fourth aspect of the disclosure, there is provided a method of designing an aerofoil arrangement, the method comprising:

determining an in-use oncoming flow velocity U;
determining an in-use principle frequency f of incoming noise at the oncoming flow velocity; and

providing an aerofoil comprising a row of apertures spaced from the leading edge a distance L₀, where L₀ is defined by the equation:

$${L}_{0} = \frac{U}{f}$$

The aerofoil arrangement may comprise first and second aerofoils, the first aerofoil being upstream in use of the second aerofoil, wherein the method may comprise providing the row of apertures on the second aerofoil.

The method may comprise determining a blade passing frequency in use of the first aerofoil relative to the second aerofoil;

and wherein f is between the blade passing frequency and three times the blade passing frequency.

The skilled person will appreciate that except where mutually exclusive, a feature described in relation to any one of the above aspects of the present disclosure may be applied mutatis mutandis to any other aspect of the present disclosure.

### DESCRIPTION OF THE DRAWINGS

Embodiments of the present disclosure will now be described by way of example only, with reference to the Figures (which are not to scale), in which:

FIG. 1 is a schematic side view of a gas turbine engine incorporating an aerofoil;

FIG. 2 is a schematic plan view of an aerofoil of the gas turbine engine of FIG. 1;

FIG. 3 is a schematic plan view of region A of the aerofoil of FIG. 2;

FIG. 4 is a cross-sectional side view of the aerofoil of FIGS. 2 and 3;

FIG. 5 is a graph showing noise amplitude plotted against non-dimensional frequency for the aerofoil of FIGS. 1 to 4 at three different oncoming flow velocities;

FIG. 6 is a schematic plan view of a second aerofoil;

FIG. 7 is a graph showing noise amplitude plotted against non-dimensional frequency for the aerofoil of FIGS. 1 to 4 at two different chordal lengths;

FIGS. 8A and 8B are schematic plan views of a further aerofoil in first and second configurations respectively;

FIGS. 9A and 9B are cross-sectional side views of the aerofoil of FIGS. 8A and 8B in the first and second configurations respectively;

FIG. 10 is a plan view of an aircraft having a still further aerofoil;

FIGS. 11A and 11B are schematic plan views of an aerofoil of the aircraft of FIG. 10 in first and second positions;

FIGS. 12A and 12B are cross-sectional side views of the aerofoils of FIGS. 11A and 11B, and

FIGS. 13A, 13B, and 13C are plan views of alternative aperture shapes;

FIG. 14 is a graph showing noise amplitude plotted against non-dimensional frequency for further aerofoils; and

FIG. 15 is a graph showing noise amplitude plotted against non-dimensional frequency for still further aerofoils.

### DETAILED DESCRIPTION

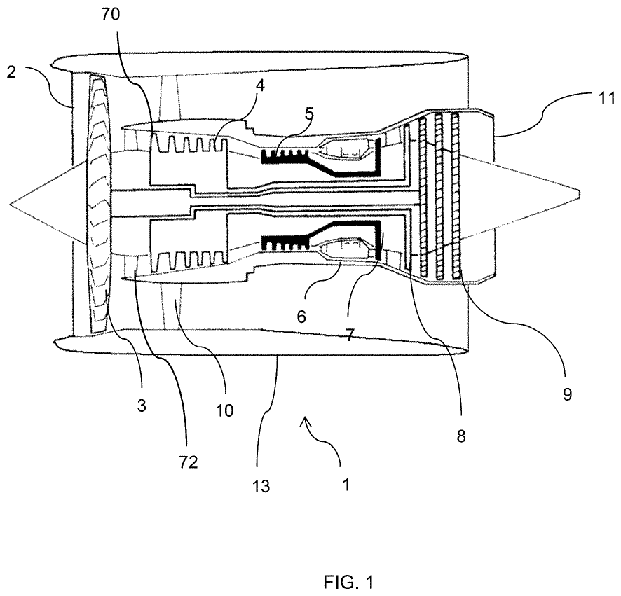

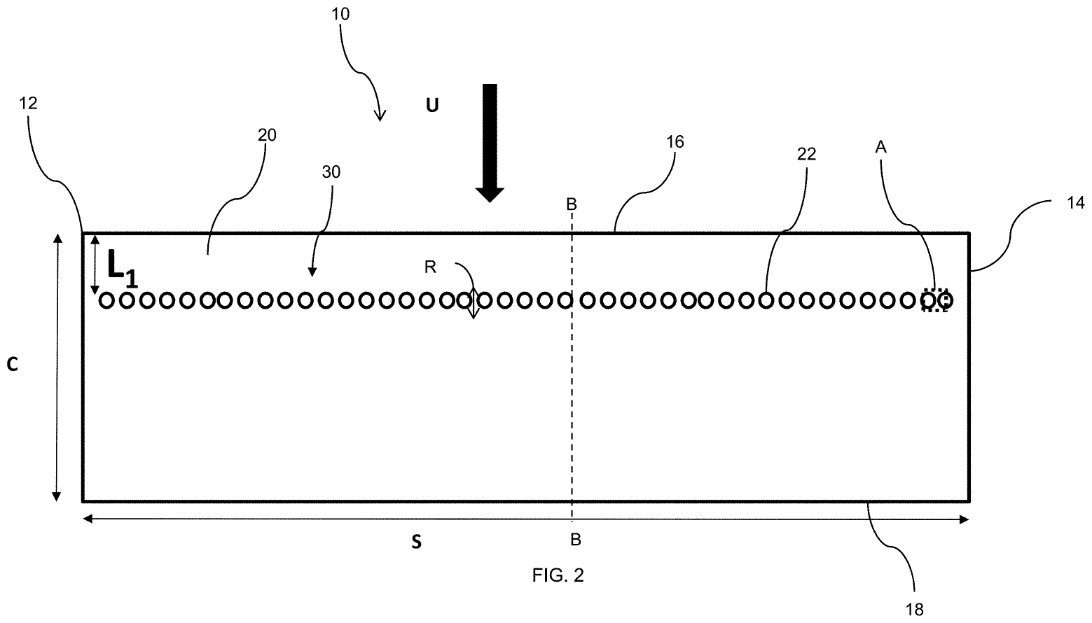

FIG. 1 shows a gas turbine engine 1 employing an aerofoil in accordance with the present disclosure. The engine 1 comprises, in axial flow series, an air intake 2, a propulsive fan 3, an intermediate pressure compressor 4, a high-pressure compressor 5, combustion equipment 6, a high-pressure turbine 7, and intermediate pressure turbine 8, a low-pressure turbine 9 and an exhaust nozzle 11. A nacelle 13 generally surrounds the engine 1 and defines both the intake 2 and the exhaust nozzle 13 to form a bypass passage. Downstream of the fan 3, an outlet guide vane 10 is provided, which comprises an aerofoil as shown in FIGS. 2 to 4. The outlet guide vane serves to straighten the flow from the fan 3 in use, to increase aerodynamic performance of the fan. As will be understood, since the OGV 10 is located downstream of the fan 3, the OGV will be subjected to turbulent flow in use. The compressors 4, 5 each comprise axial flow compressors, comprising a plurality of rotors 70 and stators 72. The rotors 70 rotate about the engine's principal axis in use, and generate an in use airflow.

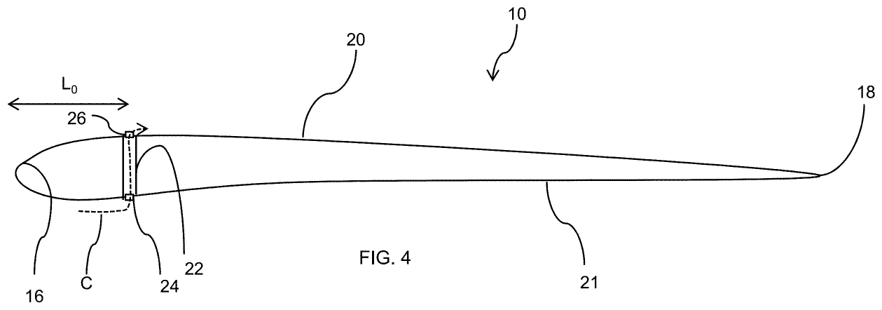

FIG. 2 shows a plan view of the outlet guide vane 10 in the form of an aerofoil 10 in accordance with the present disclosure. The aerofoil 10 defines a root 12, a tip 14, a leading edge 16, a trailing edge 18, a suction surface 20 and a pressure surface 21 (shown in FIG. 4) on the opposite side to the suction surface 20. The aerofoil 10 defines a chord length C defined by a line extending from the leading edge 16 to the trailing edge 18, generally normal to an in use oncoming airflow vector U in a direction from the leading edge 16 to the trailing edge 18. A distance between the root and tip 12, 14 defines a span S. In this embodiment, the root 12 and tip 14 are bounded by the inner and outer annulus of the bypass passage.

As can be seen, a plurality of apertures 22 are provided, spaced from the leading edge 16. The apertures 22 form a row 30 extending at least part way along the span of the aerofoil 10, in a direction parallel to the leading edge 16, generally normal to the oncoming air flow vector U. Consequently, the row 30 of apertures 22 is consistently spaced a substantially constant distance L₁ from the leading edge 16. The inventors have found that, by optionally spacing the row of apertures 22 a distance L₁ of between 2 and 6 cm, a significant reduction in broadband noise is produced, particularly within the range of frequencies easily perceived by humans, resulting in a significant reduction in perceived noise decibels (pdB) in operation.

Typically, the row of apertures 2 is spaced from the leading edge by between 25% and 40% of the chordal length of the aerofoil 10. Consequently, the effect of the apertures 2 on the aerodynamics of blade is significantly reduced compared to prior aerofoils, since the leading edge is substantially unencumbered with apertures.

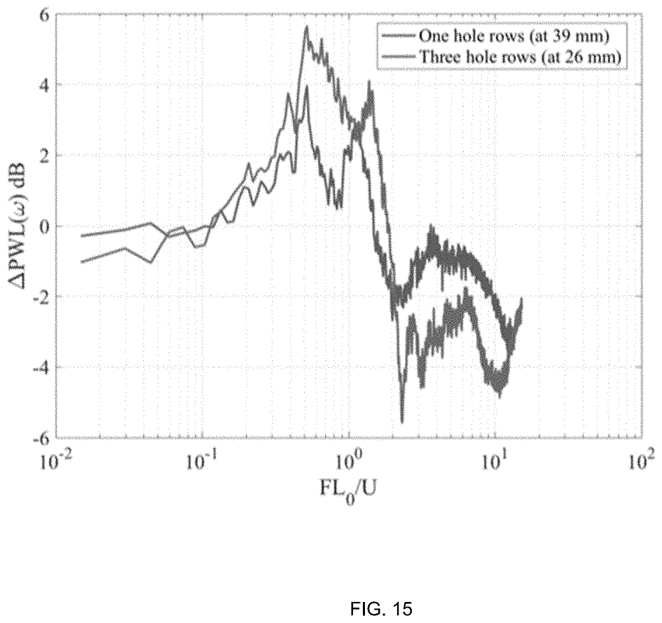

Without wishing to be restricted to theory, the mechanism by which the disclosed aerofoil 10 reduces noise is understood to be a result of the distribution of strong noise producing regions. In particular, the leading edge 16 itself represents a strong, coherent noise source, in view of interaction between eddies present in the oncoming airflow and the leading edge 16. Similarly, the apertures 22 act as a second series of noise sources. In view of the spacing L₁ between the leading edge 16 and the apertures 2, the noise from the leading edge 16 and the apertures 22 destructively interferes. This has been found to particularly be the case where the spacing is within the specified range. At smaller leading edge spacing, it has been found that high frequency noise increases markedly. For instance, FIG. 15 illustrates an aerofoil having apertures spaced only 6 mm from the leading edge. As can be seen, the perceived noise generated by the aerofoil is increased relative to an aerofoil without apertures. At larger leading edge spacing, it has been found that low frequency noise decreases markedly. Consequently, the inventors have found that significant advantages are found by spacing the apertures from the leading edge by the specified amount.

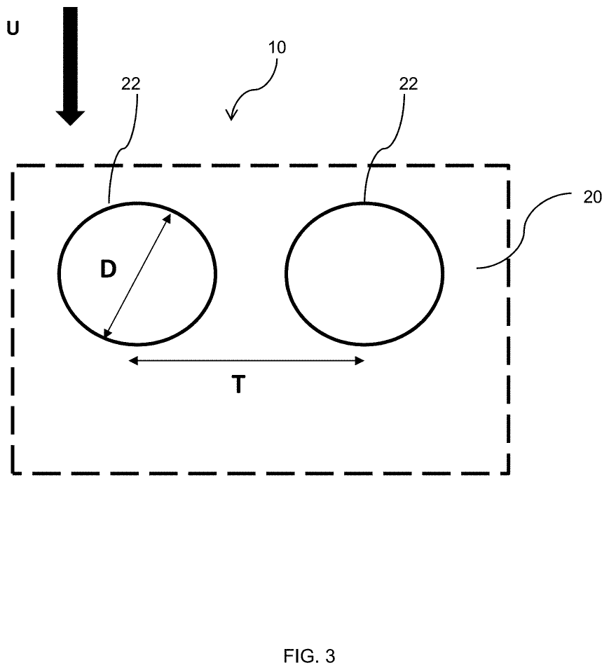

Further details of the apertures 22 are shown in FIG. 3, which shows the region A of FIG. 2. As can be seen, each aperture is generally circular, having a diameter D of between 2 and 4 mm. Each aperture 22 is spaced from an adjacent aperture 22 in the row by a spacing T, which is defined by a distance between a centre of an aperture 22 and the centre of an adjacent aperture 22. Typically, this spacing T is between 3 and 6 mm.

The chordal extent occupied by the apertures defines a porous region R. the diameter D and spacing T of the apertures 22 defines a porosity of the porous region R. Typically, this porosity is between 5 and 35%, i.e. between 5% and 35% of the porous region consists of apertures 22, while the rest of the porous region R consists of non-porous, solid material.

FIG. 4 shows a cross-section through the aerofoil 10 through line B-B of FIG. 2. As can be seen, the apertures 22 define a through hole which extends through a thickness of the aerofoil 10, from the pressure side 21 to the suction side 20. Consequently, in use, air flows through the apertures 22 from an inlet 24 at the pressure side, to an outlet 26 at the suction side, as shown by arrow C. As can be seen, the aperture 22 extends in a straight line in a direction generally normal to the suction and pressure surfaces 20, 21. This airflow generates a second line of noise sources, which provides the noise reduction effect noted above.

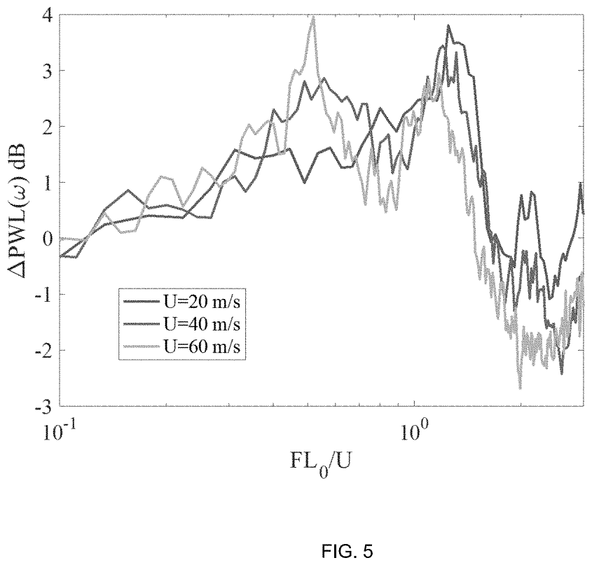

FIG. 5 shows the results of wind tunnel testing of the aerofoil 10 for a variety of airflow speeds. The tested aerofoil 10 comprises a substantially flat planar aerofoil comprising a single row of apertures 22 spaced from the leading edge 16 by a distance L₁ by 3.8 cm. The aerofoil 10 was compared to a conventional flat aerofoil not having apertures. Noise was measured by microphones in the wind tunnel and corrected to obtain a perceived noise level (pdB). Results from the aerofoil 10 and conventional aerofoil were compared, to provide a relative perceived noise level A pdB, with a positive value representing a reduction in noise, and a negative value representing an increase in noise relative to the aerofoil not having apertures. In FIG. 5, the relative perceived noise level A pdB is plotted on the ordinate axis against non-dimensional frequency FLo/U on the abscissa. Tests were conducted at incoming airstream velocities U of 20, 40 and 60 metres per second (m/s). As can be seen, a relatively consistent noise reduction A pdB is shown across a broad range of frequencies corresponding to the range of human hearing. An increase in noise at high frequencies is shown, but this is at or beyond the limit of human hearing. Furthermore, distinct peaks in noise reduction can be seen at non-dimensional frequencies of 0.5 and 1.5, which supports the theory that the noise reduction is due to destructive interference between noise generated by the leading edge, and noise generated by the apertures 22. It can be further observed that two peaks in noise reduction are observed—a first at FLo/U of 0.5, and a second at 1.5. This provides evidence that the noise reduction mechanism is related to destructive interference.

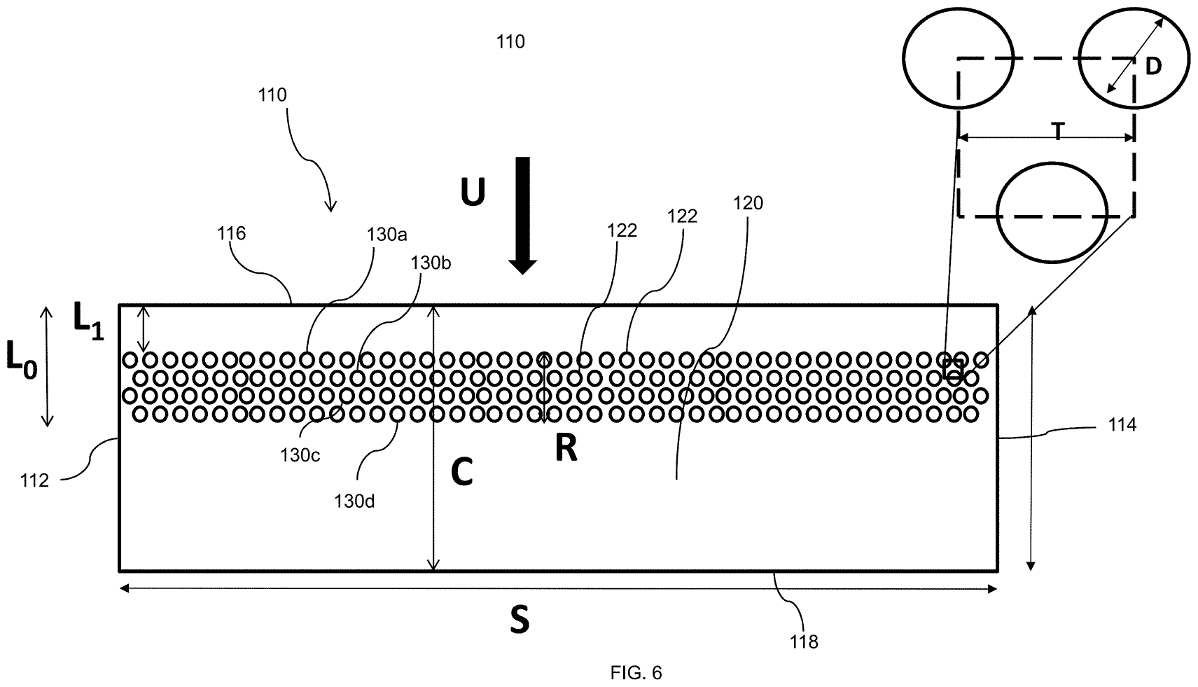

FIG. 6 shows a second aerofoil 110. The aerofoil 110 is similar to the aerofoil 10, having a root 112, a tip 114, a leading edge 116, a trailing edge 118, a suction surface 120 and a pressure surface (not shown) on the opposite side to the suction surface 120. The aerofoil 110 defines a chord length C defined by a line extending from the leading edge 116 to the trailing edge 118, generally normal to an in use oncoming airflow vector U in a direction from the leading edge 116 to the trailing edge 118. A distance between the root and tip 112, 114 defines a span S.

Again, a plurality of apertures 122 is provided. The apertures 122 are arranged into a plurality of rows, each row extending generally parallel to the leading edge 116. In this embodiment, four rows 130a-d are provided. A first row 130a is provided closest to the leading edge 116, and is separated by a spacing L₁. Again, the spacing between the leading edge 116 and the first (i.e. closest) row 130a of apertures 122 is between 2 and 6 cm. Each aperture 122 has a diameter D within each row 130a, 130b is separated by a neighbouring aperture 122 in that row by a spacing T, which are the same as the diameter D and spacing T of the first embodiment. Each row 130a, 130b is also separated by the spacing T. The rows 130a-d define a porous region R, which extends between the first 130a and last 130d rows. Again, the porous region R defines a porosity which is typically between 5% and 35%. The number of rows, in addition to the spacing and size of the apertures, can be used to tune the noise strength, and so tune the amount of destructive interference caused by the apertures.

A distance L₀ is also defined, which comprises a distance between the leading edge 116, and the trailing edge of the apertures 122 of the final row of apertures 122. In the embodiment where only a single row of apertures 122 is provided, distance L₀ is defined as the distance between the leading edge 16 and the trailing edge of the apertures of the single row.

Typically, the distance L₀ is defined by the following equation:

$${L}_{0} = \frac{U}{f}$$

Where U is the oncoming airspeed velocity, and f is a principle frequency of noise generated by an upstream component (in this case, the fan 3).

Since the noise is generated by an upstream rotating component (the fan 3), a principle source of noise is related to the blade passing frequency, i.e. the number of times per second a blade of the fan rotates past the aerofoil 122. This can be calculated by multiplying the speed of the fan in RPM by 60, then multiplying by the number of blades. Typically, a peak noise frequency occurs at approximately twice the blade passing frequency. In some cases, a peak noise frequency occurs between a first blade passing frequency, and three times the blade passing frequency.

It is typically desirable to minimise noise produced by an aircraft gas turbine engine during take-off, where the engine is at high power, noise is at a maximum, and the aircraft is close to the ground, where the noise is likely to be heard by bystanders. Consequently, it may be desirable to design the aerofoil, such that noise is minimised during operation of the engine at maximum take-off speed.

Each aircraft engine is typically designed and certificated for a maximum take-off speed, typically referred to as “100% N1”. At this speed, the fan 13 rotational speed is at its maximum, and the air flow velocity produced by the fan is also at its maximum. Consequently, both f and U can be defined for maximum take-off conditions, by determining the airflow velocity downstream of the fan 13 as it impinges on the OGV 110, and by determining the blade passing frequency at 100% N1.

Consequently, a designer can design an aerofoil by first calculating the values of f and U for conditions at which maximum noise attenuation is required (for example, maximum take-off power conditions for a gas turbine engine), and then providing a leading edge having a plurality of apertures provided spaced from the leading edge, having a downstream edge of the row of apertures furthest from the leading edge having a value of L₀ as defined by the above equation. Consequently, a method of designing an aerofoil is provided, which provides for a predictable reduction in noise at targeted conditions, without compromising strength of the aerofoil, or its aerodynamic performance.

Several advantages are provided where multiple rows of apertures are provided. For instance, different noise frequencies can be targeted by different rows, by varying the spacing between apertures in each row. Consequently broadband noise reduction can be achieved, by targeting multiple frequencies with multiple rows of apertures.

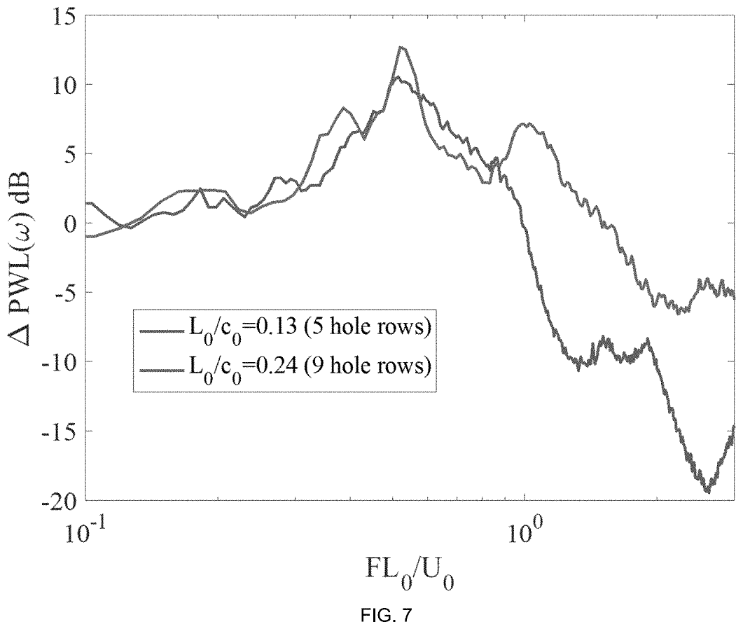

FIG. 7 shows a comparison between two further aerofoils, one of which has five rows of apertures, while the other has nine rows of apertures. The aerofoil having five rows of apertures defines an L₀ distance of 13% of the chordal length C₀, while the aerofoil having nine rows of apertures defines an L₀ distance of 24% of the chordal length C₀. As can be seen, as the number of apertures increases, noise attenuation is improved at low frequencies, but significantly worsened at higher frequencies. Consequently, the number of rows of apertures can be tailored to target a specific range of frequencies. In general however, increasing the number of rows of apertures such that the apertures covers more than approximately 40% of the chordal length of the aerofoil has been found to result in inferior noise attenuation for the frequencies in the typical range of hearing for humans.

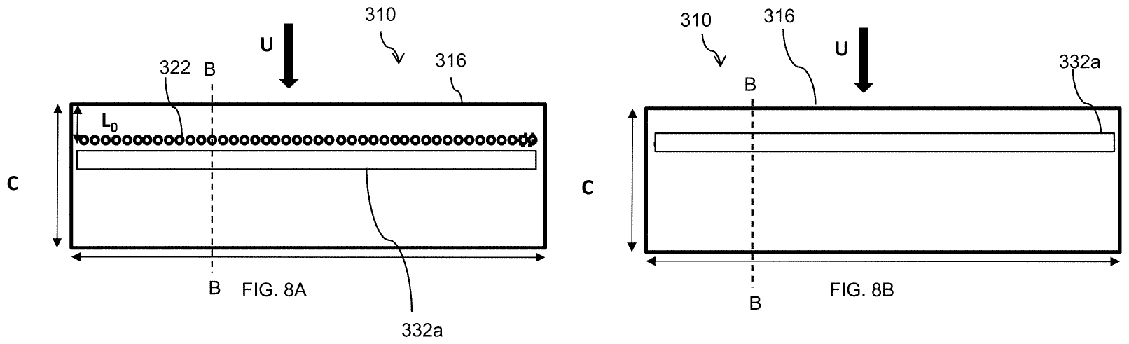

FIGS. 8A and 8B show a third aerofoil 310. This aerofoil 310 is in accordance with the present disclosure, having a row of apertures 322 spaced from a leading edge 316. The aerofoil 310 is similar to the aerofoils 10, 110, and therefore those similarities will not be described again. However, this aerofoil 310 differs from the aerofoils 10, 110, by having a moveable cover 332a.

The cover 332a is moveable from a first position (shown in FIG. 8A), to a second position (shown in FIG. 8B). The cover 332a comprises a substantially non-porous material, and is configurable to be movable to cover the apertures 322 (in the first position) or uncover the apertures 322 (in the second position). In the first position 322, the apertures 322 are uncovered, and so are able to reduce the noise produced by the aerofoil 310 in normal operation. However, the apertures 322 may be delicate, and may be prone to ice accretion, damage due to foreign object impacts, and may negatively affect aerodynamic performance of the aerofoil 310. Consequently, the cover 332a is moveable to the second position, whereby the apertures 322 are covered, thereby overcoming these disadvantages.

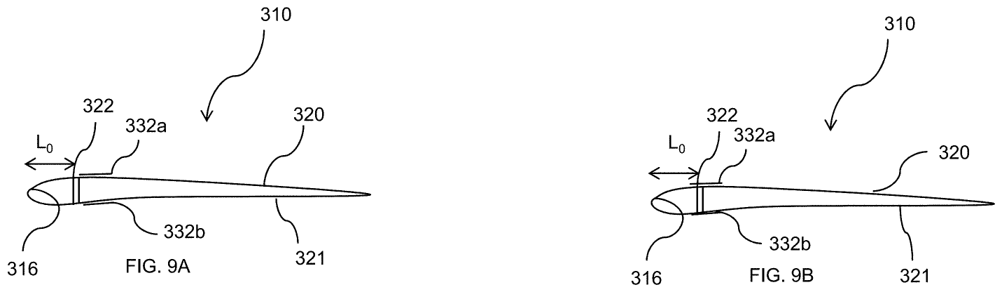

FIGS. 9A and 9B show the aerofoil 310 in cross section through the line B-B of FIGS. 8A and 8B. As can be seen, two covers 332a, 332b are provided, with one on a suction surface 320, and another on the pressure surface 321. Consequently, both sides of the apertures 322 are blocked when the covers 322a, 332b are in the covered position.

Although the aerofoil has been described in relation to an outlet guide vane of a gas turbine engine, it will be understood that the principles disclosed herein are applicable to a wide variety of aerofoils, particularly those that encounter turbulent air from upstream sources.

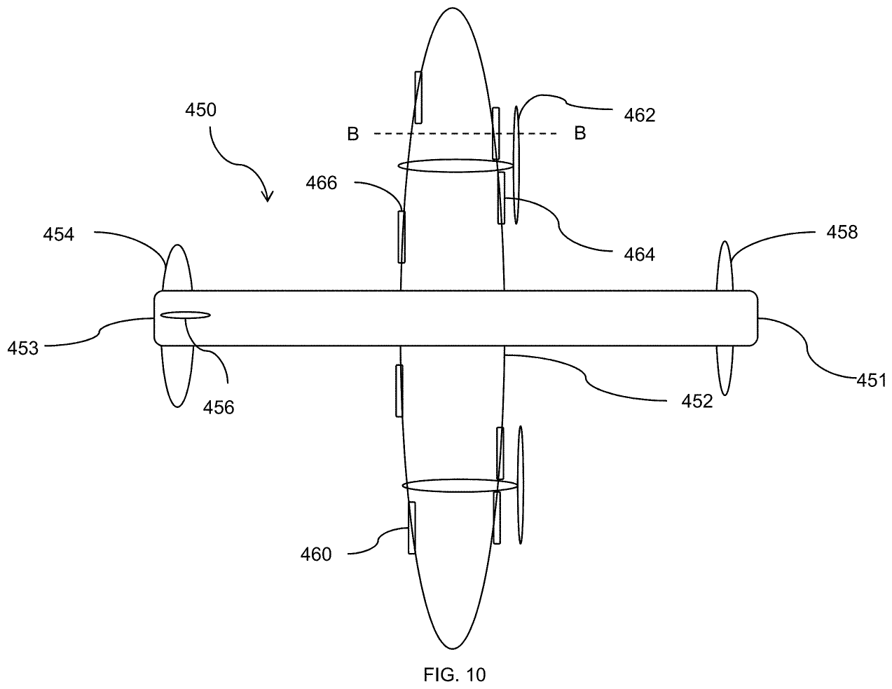

For example, FIG. 10 shows an aircraft 450 having a nose 451 and a tail 453. The aircraft 450 comprises a pair of wings 452, an empennage comprising horizontal and vertical stabilisers 454, 456. The aircraft 450 further comprises a canard 458 and control surfaces in the form of ailerons 460.

The aircraft 450 further comprises a propulsion system comprising propellers 462 mounted to the wing 452. High lift devices in the form of slats 464 are provided downstream of the propellers 462, in their slipstream. Further high lift devices in the form of flaps 466 may also be provided.

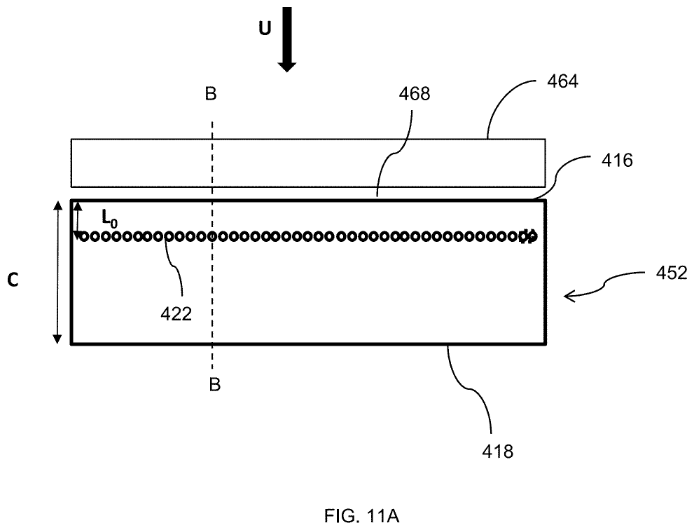

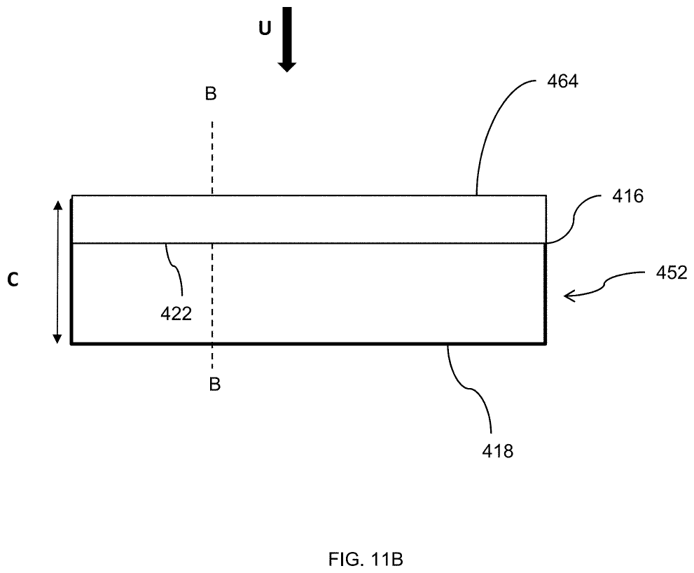

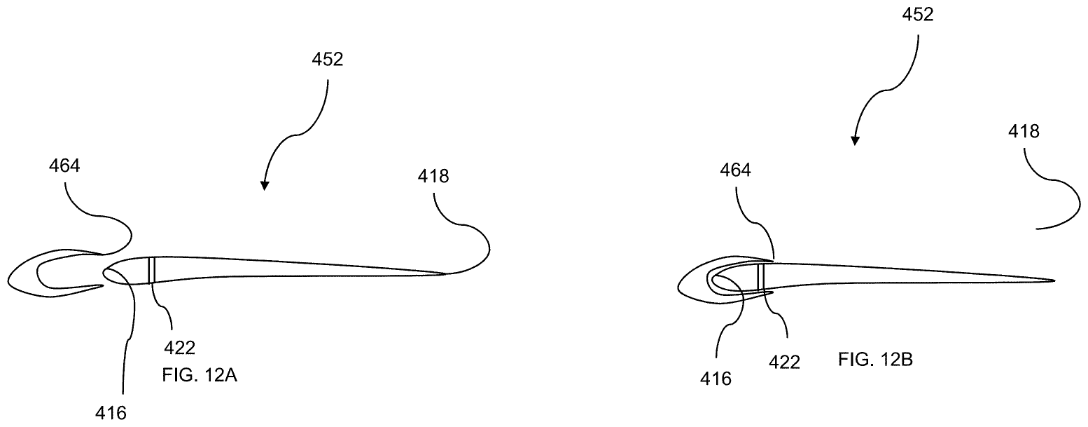

Part of the wing 452 and the slats 464 are shown in further detail in FIGS. 11A, 11B, 12A, and 12B. As can be seen, the wing 452 defines a leading edge 416 and a trailing edge 418, which define a chord length C. The slats 464 are provided upstream of the leading edge 416, and are moveable between a deployed position (shown in FIG. 11A) and a stowed position (shown in FIG. 11B). The wing 452 further comprises a plurality of apertures 422, which are provided in a row which is spaced from the leading edge of the wing 422 by a distance L₀, which is substantially the same as that described above. The apertures 422 are similar to the previous cases, and so will not be described in further detail.

In the deployed position, the slats 464 are moved forward, and are spaced from the leading edge 416, such that a gap 468 is defined between the leading edge 416 and the slat 464 through which air can flow. The spacing L₀ is defined by the distance between the apertures 422 and the leading edge 416 of the wing 452 when the slat is in the deployed position, and the apertures 422 are uncovered.

In the stowed position, as shown in FIG. 11B, the apertures 422 are covered, in a similar manner to the embodiment shown in FIGS. 8A, 8B, 9A and 9B. Again, this results in reduced aerodynamic penalty, in addition to reduced damage due to impacts with foreign objects and ice accretion. Since noise reduction tends to be required when the aircraft is operating near to the ground, and since the aircraft typically operates at slow speeds in such a case (and so requires deployment of the high lift devices such as slats), the noise attenuation apertures can be covered and un-covered using the same actuation mechanism as the slats, thereby reducing complexity.

It will be understood that the apertures could be applied to substantially any aerofoil of the aircraft, such as the slats 464 themselves, other sections of the wing 452, the horizontal or vertical stabilisers 454, 456, canard 458 or the control surfaces such as the ailerons 460.

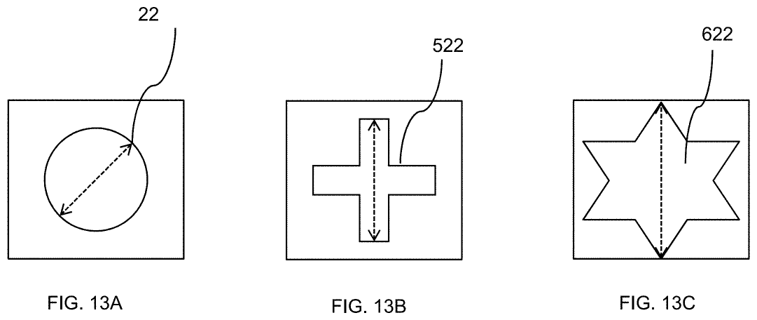

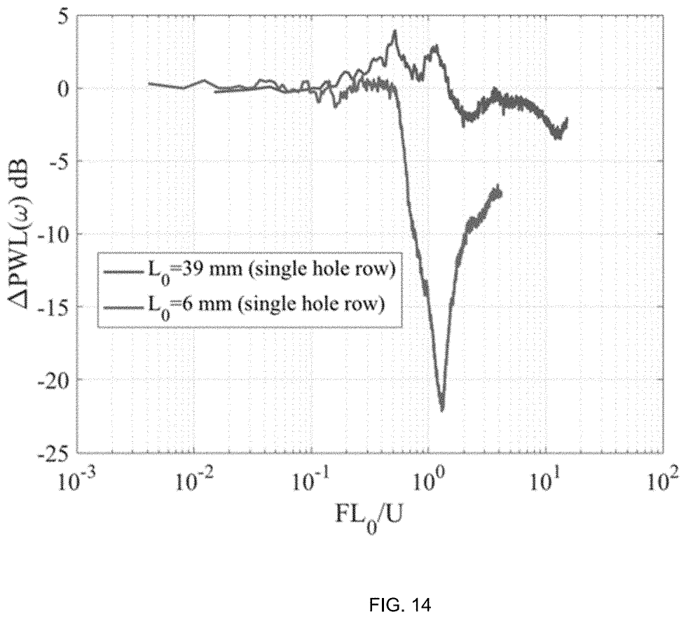

FIGS. 13A, 13B and 13C show alternative profiles for the apertures 22, 222, 322, 422. In FIG. 13A, the apertures 22 are generally circular when viewed from the suction or pressure surface. Such apertures 22 are relatively easy to form, and can for example be formed by drilling through from either the pressure or suction surface. Furthermore, since the apertures 22 do not have sharp edges, stress concentrations are avoided, which results in less structural fatigue.

FIG. 13B shows an alternative profile for an aperture 522, which could be used with any of the above embodiments. The apertures 522 have a cross-shaped aperture, which again extends between the pressure and suction surfaces of the aerofoil. In such a case, the width of the apertures 522 is defined by its diameter.

Similarly, FIG. 13C shows an further alternative profile for an aperture 622, which could be used with any of the above embodiments. The apertures 622 have a star-shaped aperture 622, which again extends between the pressure and suction surfaces of the aerofoil. Any number of “points” could be provided, such as five, six or more.

It will be understood that embodiment of the present disclosure are not limited to the embodiments above-described and various modifications and improvements can be made without departing from the concepts described herein. For example, embodiments of the present disclosure could be employed in aerofoils of different parts of a gas turbine engine, different parts of an aircraft, or in non-aviation applications, such as wind turbines, marine propellers, industrial cooling fans, and other aerofoils in which noise is a consideration. The disclosed arrangement has been found to be effective for a wide range of aerofoil cross sectional profiles, and also for flat plate aerofoils. In particular, the disclosed arrangement has been found to be particularly effective where aerodynamic noise caused by interaction of an aerofoil with upstream turbulence forms a dominant noise source.

It will be understood that the apertures may not be applied to the whole of the span of the aerofoil. The apertures may be applied to swept aerofoils, in which incident flow travels in a direction which is not parallel to the chord.

Except where mutually exclusive, any of the features may be employed separately or in combination with any other features and the disclosure extends to and includes all combinations and sub-combinations of one or more features described herein.

1. An aerofoil having a leading edge, a trailing edge, a suction surface and a pressure surface, the leading edge comprising a plurality of apertures extending through the aerofoil from the suction surface to the pressure surface, the plurality of apertures defining a first row spaced from the leading edge, wherein the first row of apertures is spaced a distance of between 2 and 6 cm from the leading edge in a chordal direction.

2. An aerofoil according to claim 1, wherein the first row of apertures is spaced from the leading edge by between 25% and 40% of a chordal length of the aerofoil.

3. An aerofoil according to claim 1, wherein aerofoil component defines a distance comprising a distance between the leading edge and a downstream end of a row of apertures furthest from the leading edge, the distance L₀ being defined as:
$${L}_{0} = \frac{U}{f}$$
where U is an in-use oncoming airspeed velocity, and f is an in-use principle frequency of noise impinging on the leading edge.

4. An aerofoil according to claim 1, wherein at least one aperture defines a width of between 2 and 4 mm.

5. An aerofoil according to claim 1, wherein at least one aperture defines a generally circular profile when viewed from above the suction or pressure surface.

6. An aerofoil according to claim 1, wherein at least one aperture defines a generally cross-shaped or star-shaped profile.

7. An aerofoil according to claim 1, wherein the or each row of apertures comprises a spanwise aperture spacing of between 3 and 6 mm.

8. An aerofoil according to claim 1, wherein the aerofoil comprises a plurality of rows of apertures.

9. An aerofoil according to claim 1, wherein the row or rows of apertures defines a porous region of the aerofoil having a porosity of between 5% and 35%.

10. An aerofoil according to claim 1, wherein the aerofoil comprises a cover moveable between a first position in which one or more apertures are exposed, and a second position in which one or more apertures are covered by the cover.

11. An aerofoil according to claim 1, wherein the aerofoil component comprises an aerofoil of a gas turbine engine, such as an outlet guide vane provided downstream in use of a fan, or a stator or rotor of an axial flow compressor.

12. A gas turbine engine comprising an aerofoil component in accordance with claim 1.

13. A gas turbine engine according to claim 12, wherein the gas turbine engine is configured to define an in use maximum airflow velocity as measured at a leading edge of the aerofoil component, and wherein the aerofoil component defines a distance comprising a distance between the leading edge and a downstream end of a row of apertures furthest from the leading edge, the distance being defined as:
$${L}_{0} = \frac{U}{f}$$
where U is the oncoming airspeed velocity, and f is a principle frequency of noise generated by the upstream component.

14. An aircraft comprising an aerofoil component according to claim 1.

15. An aircraft according to claim 14, wherein the aerofoil component comprises one of a wing, a vertical stabiliser, a horizontal stabiliser, a canard, a high lift device, and a control surface.

16. A method of designing an aerofoil arrangement, the method comprising:
determining an in-use oncoming flow velocity U;
determining an in-use principle frequency f of incoming noise at the oncoming flow velocity; and
providing an aerofoil comprising a row of apertures spaced from the leading edge a distance L₀, where L₀ is defined by the equation:
$${L}_{0} = \frac{U}{f}$$

17. A method according to claim 16, wherein the method comprises determining a first and a third blade passing frequency in use of the first aerofoil relative to the second aerofoil;
wherein f is between the blade passing frequency and three times the passing frequency.
